(19) United States
(12) Patent Application Publication
(10) Pub. No.: US 2026/0307323 A1
(43) Pub. Date: Oct. 8, 2026

(54) TRAY THERMOFORMING APPARATUS

(71) Applicant: Cryovac, LLC, Charlotte, NC (US)

(72) Inventors: Bradley Neal Daley, Huntersville, NC (US); Barry Lee Wardlaw, Belton, NC (US); Robert Babrowicz, Tega Cay, SC (US)

(21) Appl. No.: 19/478,905

(22) PCT Filed: Apr. 25, 2024
(86) PCT No.: PCT/US2024/026149

§ 371 Date: Oct. 27, 2025

Related U.S. Application Data
(60) Provisional application No. 63/462,244, filed on Apr. 26, 2023.

(51) Int. Cl. B29C 51/14; B29C 51/08; B29C 51/18; B29K 105/00; B29L 31/00

(52) U.S. Cl. CPC B29C 51/145; B29C 51/085; B29C 51/18; B29K 2105/256; B29L 2031/7132

(57) ABSTRACT

A thermoforming apparatus and a method of manufacturing a fiber-based tray. The thermoforming apparatus having a male and a female portion. The male portion having a protruding section and a secondary protrusion which contacts a compressed fiber web of unwoven fiber material prior to the remaining portions of the protruding section. Advancement mechanisms retract the secondary protrusion such that the male and female portions compress the fiber web to thermoform a tray.

### BACKGROUND

The subject matter disclosed herein relates to a tray forming apparatus and a method of manufacturing a tray.

Fiber based trays provide a more sustainable alternative to polystyrene-based trays. Forming fiber-based trays from fluff pulp or dry airlaid process often retain gases.

These gases must be removed in order to form a tray that is visual appeasing a structurally sound.

Fluff pulp and fiber made from a dry airlaid process are used to produce absorbent materials. Both are readily available. However, the absorbent properties of fiber materials are a hinderance to a food packaging article since the absorbing material would allow moisture to seep into the food packaging, thereby compromise the integrity of the package.

The discussion above is merely provided for general background information and is not intended to be used as an aid in determining the scope of the claimed subject matter.

### BRIEF DESCRIPTION

A thermoforming apparatus and a method of manufacturing a fiber-based tray. The thermoforming apparatus having a male and a female portion. The male portion having a protruding section and a secondary protrusion which contacts a compressed fiber web of unwoven fiber material prior to the remaining portions of the protruding section. Advancement mechanisms retract the secondary protrusion such that the male and female portions compress the fiber web to thermoform a tray.

An advantage that may be realized in the practice of some disclosed embodiments of the thermoforming apparatus is formation of a tray having less trapped gas, higher yield, and less tearing.

In one exemplary embodiment, a thermoforming apparatus is disclosed. The thermoforming apparatus has a female portion having an upper surface and a recessed opening; and a male portion have a protruding section and a secondary protrusion situated within the protruding section. The advancement mechanism is in communication with the secondary protrusion, the advancement mechanism causing the secondary protrusion to extend beyond the surface of the protruding section.

In another exemplary embodiment, a process for forming a fiber-based thermoformed tray is disclosed. The process having the steps of:
a. advancing a compressed fiber web of unwoven fiber material between a female portion and a male portion;
   i. the female portion having an upper surface and a recessed opening;
   ii. the male portion have a protruding section and a secondary protrusion situated within the protruding section;
   iii. at least one advancement mechanism in communication with the secondary protrusion, the advancement mechanism causing the secondary protrusion to extend beyond the surface of the protruding section.
b. bringing the secondary protrusion into contact with the compressed fiber;
c. advancing the secondary protrusion causing the compressed fiber web to come in contact with a base section of the recessed opening of the female portion;
d. advancing the male portion causing the compressed fiber web to come in contact with the recessed opening;
e. applying sufficient force and heat to compress the fiber web between the female portion and the male portion to thermoform a tray;
f. separating the male portion and the female portion.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is view of an exemplary thermoformed tray made according to some embodiments.

FIG. 2 is an isometric cross-sectional view of a thermoforming apparatus in the open position according to some embodiments.

FIG. 3 is an isometric cross-sectional view of a thermoforming apparatus as the secondary protrusion comes in contact with the female portion according to some embodiments.

FIG. 4 is an isometric cross-sectional view of a thermoforming apparatus in the nearly closed position according to some embodiments.

FIG. 5 is an isometric cross-sectional view of a thermoforming apparatus in the closed position according to some embodiments.

FIG. 6 is an isometric cross-sectional view of a thermoforming apparatus at the beginning of opening according to some embodiments.

FIG. 7 is an isometric cross-sectional view of a thermoforming apparatus as the protruding portion separates and the secondary protrusion remains in contact according to some embodiments.

FIG. 8 is an isometric cross-sectional view of a thermoforming apparatus in the open position according to some embodiments.

FIG. 9 is a schematic view of a thermoforming process according to some embodiments.

### DETAILED DESCRIPTION

A thermoforming apparatus for making a fiber-based tray. The thermoforming apparatus has a male portion and a female portion. The male portion having a protruding section and a secondary protrusion which contacts a compressed fiber web of unwoven fiber material prior to the remaining portions of the protruding section.

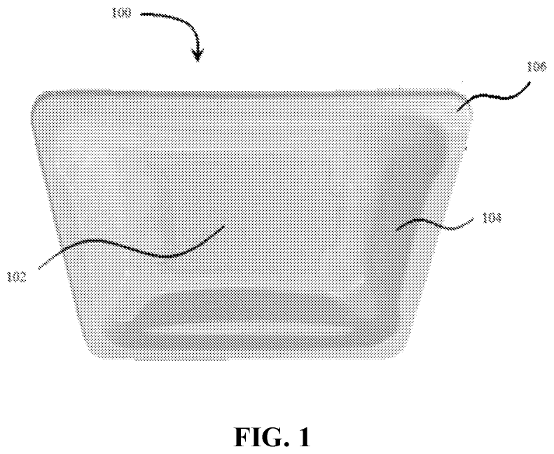

FIG. 1 is a view of a thermoformed tray made according to embodiments disclosed herein. It is understood that the shape and dimensions of the tray are not intended to be limiting and the depiction is provided to aid in the understanding of the disclosure herein. For example, while a rectangular tray is shown, oval and other shapes are contemplated. Likewise, the tray may include features such as ridges, troughs, stacking lugs and texture without detracting from the claims. Turning back to FIG. 1, the tray 100, has a base 102 and sidewalls 104 extending upward from the base 102 to an upper periphery 106 of the tray 100. In embodiments, the upper periphery 106 is a flat surface sufficient to provide a sealing surface for a lidding film.

Airlaying, also sometimes referred to as air forming is a method of forming a web by mixing fibers with air to fluff the fibers. The air fiber mixture is then deposited on a moving web such as a paper membrane, thin film, belt, wire, or screen. In some cases the air fluff mixture has sufficient inter-fiber strength to be transported without the need for a moving support web. Pressure differences and vacuums may be utilized to help the moving web keep its shape. The fibers in the airlaying process or transported and formed in their dry state, without the need for excess moisture or water. This is a distinction from typical wetlaid processes. Airlaying is often used to make absorbent fluff pulp, the type often used in absorbent materials such as diapers.

Fibers are readily available, repulpable and compostable, making their use desirable for sustainability. The unwoven fiber web is a sustainable product. Unwoven fibers, such as natural fibers are provided from fluff pulp or formed into web or sheets via a dry air laid process. Fluff pulp is commercially available from a number of supplies and is well known. Typically fluff pulp and dry airlaid fibers have a moisture content of 5-10%. The low moisture content eliminates the need for additional drying processes. An advantage of the dry air laid process is that materials can start with standard pulp fibers in bulk or in roll form. The pulp fibers are hammermilled and vacuum conveyed through a forming head to create a non-woven web. The hammermill can be designed to defiberizer the fluff pulp while limiting destruction of the fibers. For example, if the fluff pulp has a fiber length of about 2.8 mm the fiber exiting the hammermill will also have a fiber length of about 2.8 mm.

Fibers include, but are not limited to, virgin cellulose-based fibers, recycled fibers, such as paper fibers, kraft paper, textiles, wood-based fibers, cotton, linen, hemp, sugar cane or grains. Fibers may be untreated or treated with additional materials to enhance properties of the web.

The compressed fiber web is made from a fiber-based material. The fiber-based material can be provided as a roll or sheet of fluff pulp material or may be made from an airlaid process. Fluff pulp is commercially and readily available. The first step of the airlaid process is the fiberization process where pulp material, such as fluff pulp is fiberized before the actual air laid process. Pulp material may be provided in a bale, sheet or a roll. The pulp material is fed into a defibrator such as a hammermill, which fiberizes the pulp material into loose fibers by small hammers that rotate at high speed to separate the pulp into loose fibers.

The loose fibers are then then transported to a web forming system. In certain processes the loose fibers are sifted through a coarse screen and deposited with the aid of a vacuum onto a forming wire or substrate below. In other processes, the loose fibers pass through a series of holes or slots in a large cylinder that spans the width of the forming wire. In both options, the sheet of loose fibers is kept in place by a vacuum system that can be located below the forming wire to form an unwoven fiber web. Binders, coatings and other additives can be used to further aid in forming.

In embodiments a supporting layer is included on the top, the bottom or both the top and bottom of the unwoven fiber web. The supporting layer(s) aid in the handling of the web. In an embodiment the supporting layer(s) are a fiber-based tissue.

The loose fibers may be blown, or vacuum pulled onto a first supporting layer. A second supporting layer creates a three-layer structure that is compacted to form an airlaid web. Techniques for generating an airlaid web are known to those skilled in the art. For example, web formation through rotating forming drums and needle rollers. The description herein is one such method. Variations of forming an airlaid web will be understood to those skilled in the art to form the compressed fiber web.

In embodiments the compressed fiber web has a basis weight of between any of the following ranges, 300 to 1100 grams per square meter (gsm), 350 to 900 gsm, 400 to 700 gsm, 450 to 500 gsm measured in accordance with ASTM D-3776 with the sample size being adjusted to a 7 cm by 7 cm square. In embodiments the compressed fiber web has a basis weight of less than any of 1100 gsm, 1000, gsm, 900 gsm, 800, gsm, 700 gsm, 600 gsm, or 500 gsm measured in accordance with ASTM D-3776 with the sample size being adjusted to a 7 cm by 7 cm square.

In embodiments in which the fiber is made from an airlaid web, binders and/or coatings may be applied. Suitable binders and coatings include but are not limited to starch, spray binder polymers, dispersions, sol-gel, natural wax (aqueous or 100% solid), polymer latex, polyvinyl acetate, hot melt adhesive coatings, starch-wax emulsions, and blends thereof. Typically, binders are applied in an amount of 20 wt % or less.

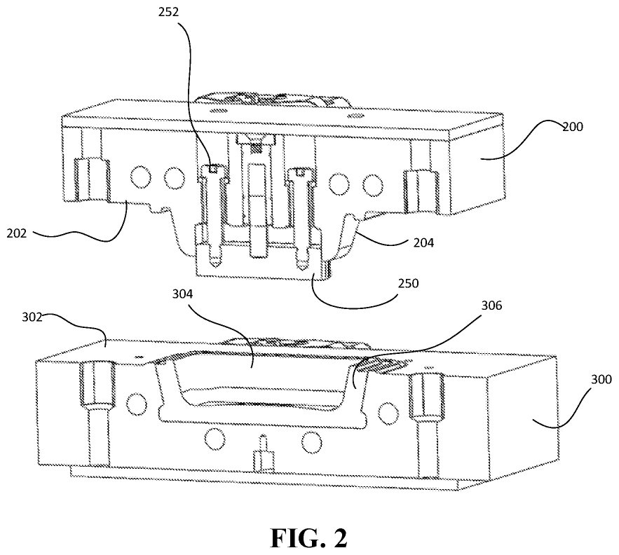

Turning now to FIG. 2, a thermoforming apparatus in the open position is shown. The thermoforming apparatus includes a male portion 200 having a surface 202 and a protruding section 204 protruding from and away from the surface 202. In embodiments the protruding section 204 is shaped into the desired shape of the tray. While a rectangular design is shown with a flange and lip is shown, other designs are contemplated.

Extending from the protruding section 204 is a secondary protrusion 250. The secondary protrusion 250 extending beyond the protruding section 204. One or more advancement mechanisms are utilized to independently move the secondary protrusion 250 compared to the protruding section 204 or male portion 200 as a whole.

In embodiments the advancement mechanisms are springs. The springs will keep the secondary protrusion 250 in the extended position until a force compresses the secondary protrusion back and into the male portion. In other embodiments the advancement mechanisms may be pistons, such as hydraulic, electric, or pneumatic pistons. In embodiments the secondary protrusion may be independently operated as compared to the male portion.

The thermoforming apparatus includes a female portion 300 having a surface 302 and a recessed opening 304 in the surface 302. The recessed opening 304 further contains a deformable insert 306. The exposed surface of the deformable insert being in the general shape of a tray. Additional feature such as ridges, stacking lugs, flanges, grooves and the like can be included to give the tray the desired features. In embodiments the deformable insert is made from a material having a Poisson's ratio of about 0.5. In embodiments the deformable insert has a first height near the center portion which is greater than a second height near the perimeter. In embodiments, the deformable insert is made from rubber.

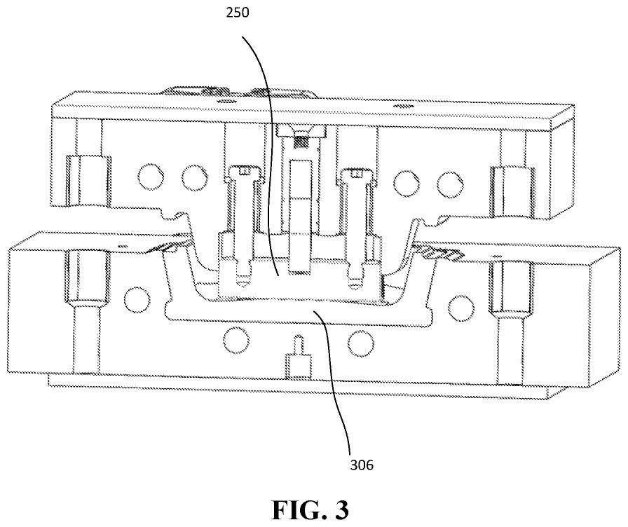

Turning now to FIG. 3 the thermoforming apparatus is shown in a position that the secondary protrusion comes in contact with the female portion. While the compressed fiber web is not shown, it is understood that the web would be fed between the male and female portions. The secondary protrusion 250 would press upon the compressed fiber web on one side and bring it into contact with the deformable insert 306 on the other side. This action locks the web in place and also begins press gas from the web. Since the male and female portions are not yet closed, the gas in the web can readily escape.

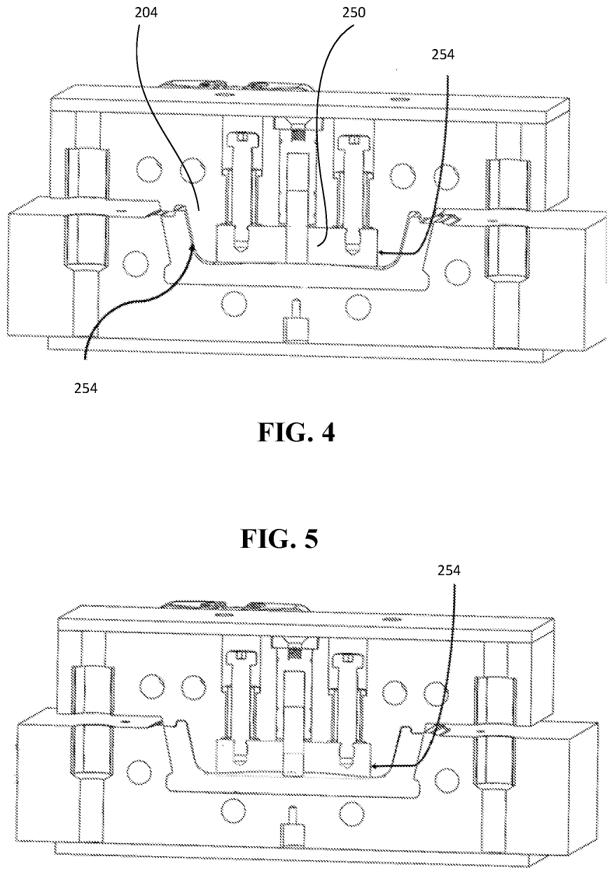

As more pressure is applied, the advancement mechanisms 252 retract as shown in FIG. 4. The secondary protrusion 250 recess into the protruding section 204 and the compressed fiber web is pressed further along the area between the protruding section 204 and the deformable insert 306. Vent gaps 254 remain both between the male and female portions as well as optionally along the secondary protrusion 250. These vent gaps allow trapped gas to escape the web and tooling.

Turning to FIG. 5 the thermoforming apparatus in the closed position at appropriate time, pressure and temperature to form the desired tray. As can be seen, the deformable insert fills the small gaps along the outermost edge which define the edge of the tray.

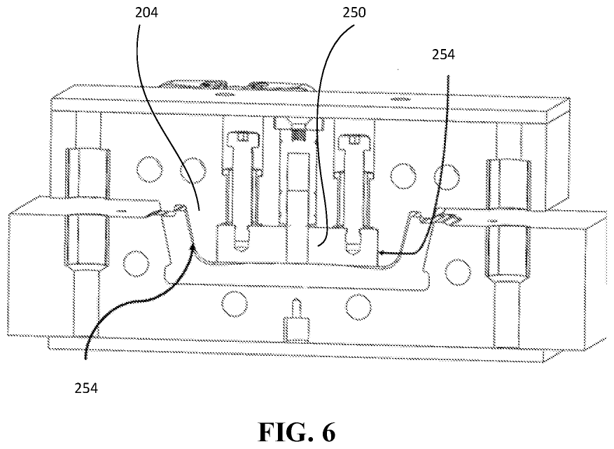

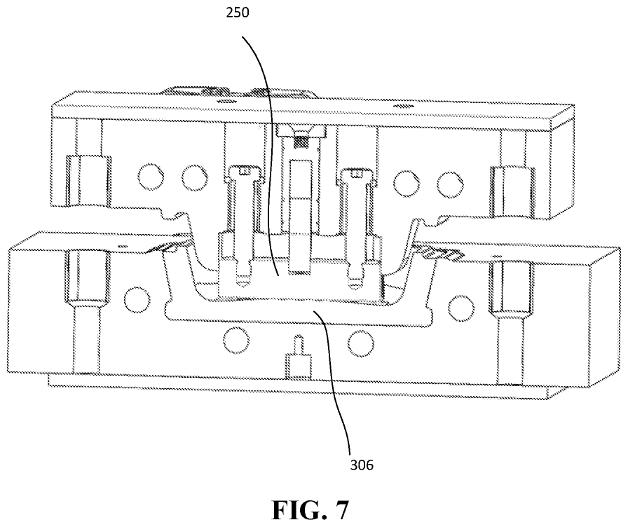

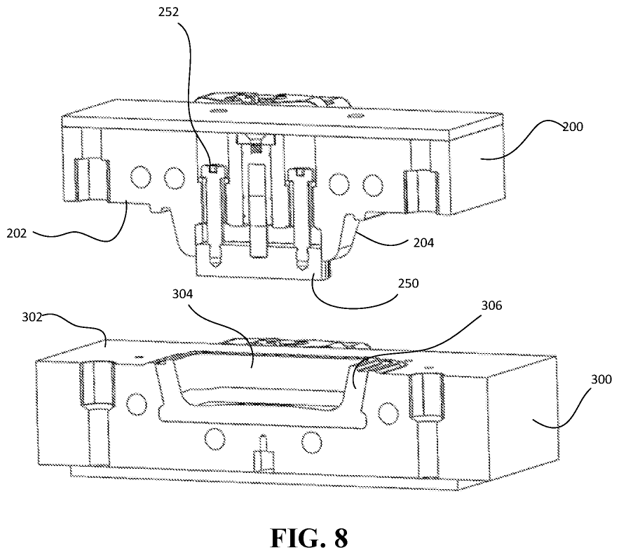

As the thermoforming apparatus begins opening as shown in FIGS. 6-7, the secondary protrusion 250 remains in contact with the tray holding it in place against the deformable insert 306. As the thermoforming apparatus fully opens as shown in FIG. 8, the tray can be advanced, and the process begins again to form another tray.

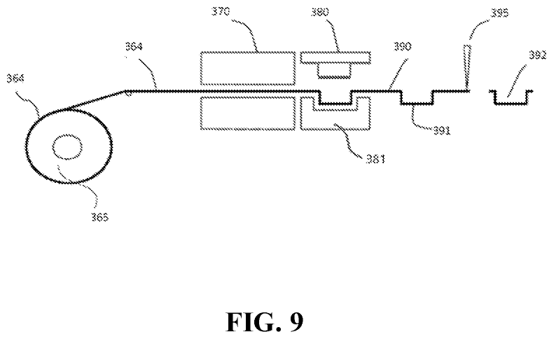

Turning now to FIG. 9 there is shown a process for thermoforming packaging articles. Compressed fiber web 364 of the multi-layer web is advanced from a roll 365. The compressed fiber web has a basis weight of between any of the following ranges, 300 to 1100 grams per square meter (gsm), 350 to 900 gsm, 400 to 700 gsm, 450 to 600 gsm measured in accordance with ASTM D-3776 with the sample size being adjusted to a 7 cm by 7 cm square. In embodiments the compressed fiber web has a basis weight of less than any of 1100 gsm, 1000, gsm, 900 gsm, 800, gsm, 700 gsm, 600 gsm, or 500 gsm measured in accordance with ASTM D-3776 with the sample size being adjusted to a 7 cm by 7 cm square.

After unrolling, the compressed fiber web 364 entering into an optional heating section to preheat the compressed fiber web. Optionally, one or more heaters 370 provide adequate heat to heat the flat sheet 364 to a suitable preform temperature. In embodiments, the heaters 370 are IR heating ovens. It is understood that other heaters such as forced air could also be employed. In embodiments, heaters are positioned both above and below the flat sheet. In embodiments, heaters above the flat sheet may be of a different temperature than the heaters below the flat sheet.

The compressed fiber web 364 is advanced to the forming section 380. In an embodiment, the at least one of the upper tooling or tooling is heated. For example, heated from a temperature from 65 ° C. to 120 ° C. Pressure of is applied sandwiching the compressed fiber web 364 between the upper tooling 381, and the lower tooling 383 causing the compressed fiber web 364 to take the shape of the tooling. In embodiments, the pressure is greater than any of 500 kN, 600 kN, 700 kN, 800 kN or 900 kN. In embodiments the pressure is applied for between 1 and 9 seconds. In certain embodiments, a vacuum is pulled through the bottom tooling to help form the material. In some instances, vacuum or positive pressure may be applied from the top mold cavity. The die then opens as the compressed fiber web has been formed into the shape of a three-dimensional packaging article 392. In embodiments, a positive pressure is applied through at least one of the upper tooling 381 or lower tooling 383 to assist in the release of the packaging article 392.

The packaging article 392 is allowed to cool and, now in the shape of a three-dimensional packaging article 392 having a base 391 is optionally allowed to cool. The three-dimensional packaging article 392 is then cut or punched out of the flat sheet with a punch out 395. The punch out may be a heated die cutter. The punch out 395 removes the material of the compressed fiber web 364 not used to form the three-dimensional try 392.

This is commonly referred to as scrap or skeleton material. Excess material from the web that are not part of the packaging article may be recycled back to the hammermill. For example, the scrap, skeleton material, trimmings, start up and end run material may be reused by sending back to the hammermill and converted again to fluff pulp. In embodiments, the thermoforming apparatus also serves as the punch out with the need for a distinct component to separate the three-dimensional tray from the skeleton material.

In embodiments, the tray may further include a film or coating disposed on one or both surfaces of the tray. The total film content being less than 15 wt % as compared to the total weight of thermoformed packaging article.

The film may be a mono-layer or multi-layer film. As used herein, the term “film” is inclusive of plastic web, regardless of whether it is film or sheet. The film can have a thickness of 0.25 mm or less, or a thickness of from 0.5 to 30 mils, or from 0.5 to 15 mils, or from 1 to 10 mils, or from 1 to 8 mils, or from 1.1 to 7 mils, or from 1.2 to 6 mils, or from 1.3 to 5 mils, or from 1.5 to 4 mils, or from 1.6 to 3.5 mils, or from 1.8 to 3.3 mils, or from 2 to 3 mils, or from 1.5 to 4 mils, or from 0.5 to 1.5 mils, or from 1 to 1.5 mils, or from 0.7 to 1.3 mils, or from 0.8 to 1.2 mils, or from 0.9 to 1.1 mils.

In embodiments, the film or coating provides water, moisture, grease, oil, or oxygen resistance properties to the compressed fiber web.

The multi-layer films may include at least, and/or at most, any of the following numbers of layers: 2, 3, 4, 5, 6, 7, 8, 9, 10, 11, 12, 13, 14 and 15. As used herein, the term “layer” refers to a discrete film component which is substantially coextensive with the film and has a substantially uniform composition. Where two or more directly adjacent layers have essentially the same composition, then these two or more adjacent layers may be considered a single layer for the purposes of this application. In an embodiment, the multi-layer film utilizes microlayers. A microlayer section may include between 10 and 1,000 microlayers in each microlayer section.

Below are some examples of combinations in which the alphabetical symbols designate the film layers. Where the multi-layer film representation below includes the same letter more than once, each occurrence of the letter may represent the same composition or a different composition within the class that performs a similar function.

A/C, A/B/C, A/D/C, A/B/D/C, A/D/B/C, A/B/D/B/C, A/D/B/D/C.

“A” represents a food contact layer, as discussed herein.

“B” represents a barrier layer, as discussed herein.

“C” represents a fiber bonding layer, as discussed herein.

“D” represents one or more other layers of the film, such as a bulk layer.

All compositional percentages used herein are presented on a “by weight” basis, unless designated otherwise.

The food contact layer of the film functions as a food contact layer and in embodiments as the seal layer in which another film, such as a lidding film, can be sealed thereto. As used herein, the phrases “seal layer”, “sealing layer”, “heat seal layer”, and “sealant layer”, refer to an outer layer, or layers, involved in the sealing of the multi-layer film to, another film, and/or another article which is not a film.

Heat seal layers include thermoplastic polymers such as thermoplastic polyolefins and ionomers. In embodiments, polymers for the sealant layer include homogeneous ethylene/alpha-olefin copolymer, heterogeneous ethylene/alpha-olefin copolymer, ethylene homopolymer, ionomer and ethylene/vinyl acetate copolymer. In some embodiments, the heat seal layer can comprise a polyolefin, particularly an ethylene/alpha-olefin copolymer. For example, a polyolefin having a density of from 0.88 g/cc to 0.917 g/cc, or from 0.90 g/cc to 0.917 g/cc, or less than 0.92 g/cc. More particularly, the seal layer can comprise at least one member selected from the group consisting of high density polyethylene, linear low density polyethylene, medium density polyethylene, low density polyethylene, very low density polyethylene, homogeneous ethylene/alpha-olefin copolymer, and polypropylene. “Polymer” herein refers to homopolymer, copolymer, terpolymer, etc. “Copolymer” herein includes copolymer, terpolymer, etc.

As used herein, the term “copolymer” refers to polymers formed by the polymerization of reaction of at least two different monomers. For example, the term “copolymer” includes the co-polymerization reaction product of ethylene and an-olefin, such as 1-octene. The term “copolymer” is also inclusive of, for example, the co-polymerization of a mixture of ethylene, propylene, 1-propene, 1-butene, 1-hexene, and 1-octene. As used herein, a copolymer identified in terms of a plurality of monomers, e.g., “propylene/ethylene copolymer,” refers to a copolymer in which either a monomer may copolymerize in a higher weight or molar percent than the other monomer or monomers. However, the first listed monomer generally polymerizes in a higher weight percent than the second listed monomer.

As used herein, the term “polyolefin” refers to olefin polymers and copolymers, especially ethylene and propylene polymers and copolymers, and to polymeric materials having at least one olefinic comonomer. Polyolefins can be linear, branched, cyclic, aliphatic, aromatic, substituted, or unsubstituted. Included in the term polyolefin are homopolymers of olefin, copolymers of olefin, copolymers of an olefin and a non-olefinic comonomer copolymerizable with the olefin, such as vinyl monomers, modified polymers of the foregoing, and the like. Modified polyolefins include modified polymers prepared by copolymerizing the homopolymer of the olefin or copolymer thereof with an unsaturated carboxylic acid, e.g., maleic acid, fumaric acid or the like, or a derivative thereof such as the anhydride, ester metal salt or the like. It could also be obtained by incorporating into the olefin homopolymer or copolymer, an unsaturated carboxylic acid, e.g., maleic acid, fumaric acid or the like, or a derivative thereof such as the anhydride, ester metal salt or the like. In an embodiment, the heat seal layer is mainly composed of polyolefin. In an embodiment, the heat seal layer has a total polyolefin content of from 90 to 99 wt % based on the total composition of the heat seal layer.

Ethylene homopolymer or copolymer refers to ethylene homopolymer such as low density polyethylene; ethylene/alpha olefin copolymer such as those defined hereinbelow; and other ethylene copolymers such as ethylene/vinyl acetate copolymer; ethylene/alkyl acrylate copolymer; or ethylene/(meth)acrylic acid copolymer. Ethylene/alpha-olefin copolymer herein refers to copolymers of ethylene with one or more comonomers selected from C4 to C10 alpha-olefins such as butene-1, hexene-1, octene-1, etc. in which the molecules of the copolymers comprise long polymer chains with relatively few side chain branches arising from the alpha-olefin which was reacted with ethylene. This molecular structure is to be contrasted with conventional high pressure low or medium density polyethylenes which are highly branched with respect to ethylene/alpha-olefin copolymers and which high pressure polyethylenes contain both long chain and short chain branches. Ethylene/alpha-olefin copolymers include one or more of the following: 1) high density polyethylene, for example having a density greater than 0.94 g/cm³, 2) medium density polyethylene, for example having a density of from 0.93 to 0.94 g/cm³, 3) linear medium density polyethylene, for example having a density of from 0.926 to 0.94 g g/cm³, 4) low density polyethylene, for example having a density of from 0.915 to 0.939 g/cm³, 5) linear low density polyethylene, for example having a density of from 0.915 to 0.935g/cm³ , 6) very-low or ultra-low density polyethylene, for example having density below 0.915 g/cm³, and homogeneous ethylene/alpha-olefin copolymers. Homogeneous ethylene/alpha-olefin copolymers include those having a density of less than about any of the following: 0.925, 0.922, 0.92, 0.917, 0.915, 0.912, 0.91, 0.907, 0.905, 0.903, 0.90, and 0.86g/cm³. Unless otherwise indicated, all densities herein are measured according to ASTM D1505.

As used herein, the phrase “modified polymer,” as well as more specific phrases such as “modified ethylene vinyl acetate copolymer,” and “modified polyolefin” refer to such polymers having an anhydride functionality, as defined immediately above, grafted thereon and/or copolymerized therewith and/or blended therewith. Preferably, such modified polymers have the anhydride functionality grafted on or polymerized therewith, as opposed to merely blended therewith.

In general, the ethylene/alpha-olefin copolymer comprises a copolymer resulting from the copolymerization of from about 80 to 99 weight percent ethylene and from 1 to 20 weight percent alpha-olefin. Preferably, the ethylene alpha-olefin copolymer comprises a copolymer resulting from the copolymerization of from about 85 to 95 weight percent ethylene and from 5 to 15 weight percent alpha-olefin.

As used herein, the phrase “heterogeneous polymer” refers to polymerization reaction products of relatively wide variation in molecular weight and relatively wide variation in composition distribution, i.e., typical polymers prepared, for example, using conventional Ziegler-Natta catalysts. Heterogeneous copolymers typically contain a relatively wide variety of chain lengths and comonomer percentages. Heterogeneous copolymers have a molecular weight distribution (Mw/Mn) of greater than 3.0.

As used herein, the phrase “homogeneous polymer” refers to polymerization reaction products of relatively narrow molecular weight distribution and relatively narrow composition distribution. Homogeneous polymers are useful in various layers of the multi-layer film. Homogeneous polymers are structurally different from heterogeneous polymers, in that homogeneous polymers exhibit a relatively even sequencing of comonomers within a chain, a mirroring of sequence distribution in all chains, and a similarity of length of all chains, i.e., a narrower molecular weight distribution. Furthermore, homogeneous polymers are typically prepared using metallocene, or other single-site type catalysis, rather than using Ziegler Natta catalysts. Homogeneous polymers have a molecular weight distribution (Mw/Mn) of less than 3.0 More particularly, homogeneous ethylene/alpha-olefin copolymers may be characterized by one or more methods known to those of skill in the art, such as molecular weight distribution (Mw/Mn), composition distribution breadth index (CDBI), narrow melting point range, and single melt point behavior. The molecular weight distribution (Mw/Mn), also known as “polydispersity,” may be determined by gel permeation chromatography. In some embodiments, the homogeneous ethylene/alpha-olefin copolymers have an Mw/Mn of less than 2.7; in another embodiment from about 1.9 to 2.5; and it yet another embodiment, from about 1.9 to 2.3. The composition distribution breadth index (CDBI) of such homogeneous ethylene/alpha-olefin copolymers will generally be greater than about 70 percent. The CDBI is defined as the weight percent of the copolymer molecules having a comonomer content within 50 percent (i.e., plus or minus 50%) of the median total molar comonomer content. The CDBI of linear polyethylene, which does not contain a comonomer, is defined to be 100%. The Composition Distribution Breadth Index (CDBI) is determined via the technique of Temperature Rising Elution Fractionation (TREF). CDBI determination clearly distinguishes homogeneous copolymers (i.e., narrow composition distribution as assessed by CDBI values generally above 70%) from VLDPEs available commercially which generally have a broad composition distribution as assessed by CDBI values generally less than 55%. TREF data and calculations therefrom for determination of CDBI of a copolymer is readily calculated from data obtained from techniques known in the art, such as, for example, temperature rising elution fractionation as described, for example, in Wild et. al., J. Poly. Sci. Poly. Phys. Ed., Vol. 20, p. 441(1982 ). In some embodiments, homogeneous ethylene/alpha-olefin copolymers have a CDBI greater than about 70%, i.e., a CDBI of from about 70% to 99%. In general, homogeneous ethylene/alpha-olefin copolymers useful in the present invention also exhibit a relatively narrow melting point range, in comparison with “heterogeneous copolymers”, i.e., polymers having a CDBI of less than 55%. In an embodiment, the homogeneous ethylene/alpha-olefin copolymers exhibit an essentially singular melting point characteristic, with a peak melting point (Tm), as determined by Differential Scanning Colorimetry (DSC), of from about 60° C. to 105° C. In an embodiment, the homogeneous copolymer has a DSC peak Tm of from about 80 ° C. to 100° C. As used herein, the phrase “essentially single melting point” means that at least about 80%, by weight, of the material corresponds to a single Tm peak at a temperature within the range of from about 60° C. to 105° C., and essentially no substantial fraction of the material has a peak melting point in excess of about 115° C., as determined by DSC analysis. DSC measurements are made on a Perkin Elmer System 7 Thermal Analysis System. Melting information reported are second melting data, i.e., the sample is heated at a programmed rate of 10° C./min to a temperature below its critical range. The sample is then reheated (2nd melting) at a programmed rate of 10° C./min.

A homogeneous ethylene/alpha-olefin copolymer can, in general, be prepared by the copolymerization of ethylene and any one or more alpha-olefin. In certain embodiments, the alpha-olefin is a C₃-C₂₀ alpha-monoolefin, a C₄-C₁₂ alpha-monoolefin, a C₄-C₈ alpha-monoolefin. In an embodiment, the alpha-olefin copolymer comprises at least one member selected from the group consisting of butene-1, hexene-1, and octene-1, i.e., 1-butene, 1-hexene, and 1-octene, respectively. In an embodiment, the alpha-olefin copolymer comprises octene-1, and/or a blend of hexene-1 and butene-1. In another embodiment, the alpha-olefin copolymer comprises a blend of at least two of octene-1, hexene-1 and butene-1.

The thickness of the food contact layer as a percentage of the total thickness of the film may be less that any of the following values: 50%, 40%, 30%, 25%, 20%, 15%, 10%, and 5%; and may range between any of the forgoing values (e.g., from 10% to 30%).

In an embodiment, the film includes a barrier layer. As used herein, the term “barrier”, and the phrase “barrier layer”, as applied to films and/or film layers, are used with reference to the ability of a film or film layer to serve as a barrier to one or more gases. Oxygen transmission rate is one method to quantify the effect of a barrier layer. As used herein, the term “oxygen transmission rate” refers to the oxygen transmitted through a film in accordance with ASTM D3985 “Standard Test Method for Oxygen Gas Transmission Rate Through Plastic Film and Sheeting Using a Coulometric Sensor,” which is hereby incorporated, in its entirety, by reference thereto.

The barrier layers include at least 50, 60, 70, 80, 90, or 95% weight of the layer of barrier polymers chosen from ethylene-vinyl alcohol copolymer, polyvinyl alcohol copolymer, polyvinylidene chloride, polyamides or blends thereof. In an embodiment the barrier layers are substantially all barrier polymers. The ethylene content of the ethylene-vinyl alcohol copolymer has an effect on the processability of multi-layer films and also has an effect on oxygen transmission rate. Generally, lower ethylene content results in a film that has a lower orientability, and may not be processable at certain orientation ratios. A higher ethylene content generally raises the oxygen transmission rate properties.

In other embodiments, ethylene-vinyl alcohol copolymers may have an ethylene content of about 38 mole %, or at least about any of the following values: 20%, 25%, 30%, 38%, 44% and 48% all mole percent. In embodiments, ethylene-vinyl alcohol copolymers may have an ethylene content of at most about any of the following values: 50%, 48%, 44%, 40%, and 38% all mole percent. In embodiments, the ethylene-vinyl alcohol copolymer or blend of ethylene-vinyl alcohol copolymers resulting in an ethylene content of between 27-48 mol %. Ethylene-vinyl alcohol copolymers may include saponified or hydrolyzed ethylene/vinyl acetate copolymers, such as those having a degree of hydrolysis of at least about any of the following values: 50%, 85%, 95%, 95%. Ethylene-vinyl alcohol copolymers may have an ethylene content ranging from about 20 mole percent to about 50 mole percent. Exemplary ethylene-vinyl alcohol copolymers include those having ethylene contents of 27, 29, 32, 35, 38, 44, 48 and 50 mole % and blends thereof.

“Polyamide” herein refers to polymers having amide linkages along the molecular chain, and preferably to synthetic polyamides such as nylons. Furthermore, such term encompasses both polymers comprising repeating units derived from monomers, such as caprolactam, which polymerize to form a polyamide, as well as polymers of diamines and diacids, and copolymers of two or more amide monomers, including nylon terpolymers, sometimes referred to in the art as “copolyamides”. Useful polyamides include those of the type that may be formed by the polycondensation of one or more diamines with one or more diacids and/or of the type that may be formed by the polycondensation of one or more amino acids. Useful polyamides include aliphatic polyamides and aliphatic/aromatic polyamides.

Representative aliphatic diamines for making poly amides include those having the formula:

H₂N(CH₂)ₙNH₂

where n has an integer value of 1 to 16. Representative examples include trimethylenediamine, tetramethylenediamine, pentamethylenediamine, hexamethylenediamine, octamethylenediamine, decamethylenediamine, dodecamethylenediamine, hexadecamethylenediamine. Representative aromatic diamines include p-phenylenediamine, 4,4′-diaminodiphenyl ether, 4,4′ diaminodiphenyl sulphone, 4,4′-diaminodiphenylethane. Representative alkylated diamines include 2,2-dimethylpentamethylenediamine, 2,2,4-trimethylhexamethylenediamine, and 2,4,4 trimethylpentamethylenediamine. Representative cycloaliphatic diamines include diaminodicyclohexylmethane. Other useful diamines include heptamethylenediamine, nonamethylenediamine, and the like.

Representative diacids for making polyamides include dicarboxylic acids, which may be represented by the general formula:

HOOC—Z—COOH

where Z is representative of a divalent aliphatic radical containing at least 2 carbon atoms. Representative examples include adipic acid (i.e., hexanedioic acid), sebacic acid, octadecanedioic acid, pimelic acid, suberic acid, azelaic acid, dodecanedioic acid, and glutaric acid. The dicarboxylic acids may be aliphatic acids, or aromatic acids such as isophthalic acid and terephthalic acid.

The polycondensation reaction product of one or more or the above diamines with one or more of the above diacids may form useful polyamides. Representative polyamides of the type that may be formed by the polycondensation of one or more diamines with one or more diacids include aliphatic polyamides such as poly(hexamethylene adipamide) (“nylon-6,6”), poly(hexamethylene sebacamide) (“nylon-6,10”), poly(heptamethylene pimelamide) (“nylon-7,7”), poly(octamethylene suberamide) (“nylon-8,8”), poly(hexamethylene azelamide) (“nylon-6,9”), poly(nonamethylene azelamide) (“nylon-9,9”), poly(decamethylene azelamide) (“nylon-10,9”), poly(tetramethylenediamine-co-oxalic acid) (“nylon-4,2”), the polyamide of n-dodecanedioic acid and hexamethylenediamine (“nylon-6,12”), the polyamide of dodecamethylenediamine and n-dodecanedioic acid (“nylon-12,12”).

Representative aliphatic/aromatic polyamides include poly(tetramethylenediamine-co-isophthalic acid) (“nylon-4,I”), polyhexamethylene isophthalamide (“nylon-6,I”), poly (2,2,2-trimethyl hexamethylene terephthalamide), poly(m-xylylene adipamide) (“nylon-MXD,6”), poly(p-xylylene adipamide), poly(hexamethylene terephthalamide), poly(dodecamethylene terephthalamide), and polyamide-MXD,I.

Representative polyamides of the type that may be formed by the polycondensation of one or more amino acids include poly(4-aminobutyric acid) (“nylon-4”), poly(6-aminohexanoic acid) (“nylon-6” or “poly(caprolactam)”), poly(7-aminoheptanoic acid) (“nylon-7”), poly(8-aminooctanoic acid) (“nylon-8”), poly(9-aminononanoic acid) (“nylon-9”), poly(10-aminodecanoic acid) (“nylon-10”), poly(11-aminoundecanoic acid) (“nylon-11”), and poly(12-aminododecanoic acid) (“nylon-12”).

Representative copolyamides include copolymers based on a combination of the monomers used to make any of the foregoing polyamides, such as, nylon-4/6, nylon-6/9, caprolactam/hexamethylene adipamide copolymer (“nylon-6,6/6”), hexamethylene adipamide/caprolactam copolymer (“nylon-6/6,6”), trimethylene adipamide/hexamethylene azelaiamide copolymer (“nylon-trimethyl 6,2/6,2”), hexamethylene adipamide-hexamethylene-azelaiamide caprolactam copolymer (“nylon-6,6/6,9/6”), hexamethylene adipamide/hexamethylene-isophthalamide (“nylon-6,6/6,I”), hexamethylene adipamide/hexamethyleneterephthalamide (“nylon-6,6/6,T”), nylon-6,T/6,I, nylon-6/MXD, T/MXD, I, nylon-6,6/6,10, and nylon-6,I/6,T.

Poly amides also include modifications and blends of those discussed above. “Polyamide” further includes amorphous, crystalline or partially crystalline, aromatic or partially aromatic polyamides.

In embodiments the barrier layer is less than 15 wt % of the film. In other embodiments, the barrier layer is less than 10 wt % of the film. In yet other embodiments, the barrier layer is less than 5 wt % of the film.

The film may include a fiber bonding layer. The primary function of the fiber bonding layer being to bond the multi-layer film to the compressed fiber web. The bonding layer including materials to that function to seal as discussed above in regards to heat seal layers. In embodiments, the fiber bonding layer includes materials with a low seal initiation temperature. In embodiments, the fiber bonding layer includes materials having a seal initiation temperature of less than 120° C., 110° C., 100° C., 90° C. or 80° C. In embodiments, the fiber bonding layer includes ethylene/vinyl acetate copolymers, ionomers or blends thereof.

The thickness of the fiber bonding layer as a percentage of the total thickness of the film may be less that any of the following values: 50%, 40%, 30%, 25%, 20%, 15%, 10%, and 5%; and may range between any of the forgoing values (e.g., from 10% to 30%).

The film may comprise one or more intermediate layers, such as a tie layer. In addition to a first intermediate layer, the film may comprise a second intermediate layer. “Intermediate” herein refers to a layer of a multi-layer film which is between an outer layer and an inner layer of the film. “Inner layer” herein refers to a layer which is not an outer or surface layer, and has both of its principal surfaces directly adhered to another layer of the film. “Outer layer” herein refers to any film layer of film having less than two of its principal surfaces directly adhered to another layer of the film. All multi-layer films have two, and only two, outer layers, each of which has a principal surface adhered to only one other layer of the multi-layer film. In monolayer films, there is only one layer, which, of course, is an outer layer in that neither of its two principal surfaces are adhered to another layer of the film. “Outer layer” also is used with reference to the outermost layer of a plurality of concentrically arranged layers of a seamless tubing, or the outermost layer of a seamed film tubing.

In embodiments with multiple intermediate layers, the composition, thickness, and other characteristics of a second intermediate layer may be substantially the same as any of those of a first intermediate layer, or may differ from any of those of the first intermediate layer.

An intermediate layer may be, for example, between the food contact layer and the barrier layer. An intermediate layer may be directly adjacent the food contact layer, so that there is no intervening layer between the intermediate and heat seal layers. An intermediate layer may be directly adjacent the barrier layer, so that there is no intervening layer between the intermediate and barrier layers. An intermediate layer may be directly adjacent both the food contact layer and the barrier layer. An intermediate layer may be, for example, between the fiber bonding layer and the barrier layer. An intermediate layer may be directly adjacent the fiber bonding layer, so that there is no intervening layer between the intermediate and fiber bonding layers. An intermediate layer may be directly adjacent the barrier layer, so that there is no intervening layer between the intermediate layer and barrier layers. An intermediate layer may be directly adjacent both the fiber bonding layer and the barrier layer.

The thickness of the intermediate layer as a percentage of the total thickness of the film may be at least about, and/or at most about, any of the following: 1%, 3%, 5%, 7%, 10%, 15%, 20%, 25%, 30%, 35%, 40%, 45%, and 50%.

An intermediate layer may comprise one or more of any of the tie polymers described herein in at least about, and/or at most about, any of the following amounts: 10%, 20%, 30%, 40%, 50%, 60%, 70%, 75%, 80%, 90%, 95%, and 99.5 %, by weight of the layer.

A tie layer refers to an internal film layer that adheres two layers to one another. Useful tie polymers include thermoplastic polymers that may be compatible both with the polymer of one directly adjacent layer and the polymer of the other directly adjacent layer. Such dual compatibility enhances the adhesion of the tied layers to each other. Tie layers can be made from polyolefins such as modified polyolefin, ethylene/vinyl acetate copolymer, modified ethylene/vinyl acetate copolymer, and homogeneous ethylene/alpha-olefin copolymer. Typical tie layer polyolefins include anhydride modified grafted linear low density polyethylene, anhydride grafted (i.e., anhydride modified) low density polyethylene, anhydride grafted very low density polyethylene, anhydride grafted polypropylene, anhydride grafted methyl acrylate copolymer, anhydride grafted butyl acrylate copolymer, homogeneous ethylene/alpha-olefin copolymer, and anhydride grafted ethylene/vinyl acetate copolymer.

The film may include one or more other layers such as a bulk layer. Bulk layers are often a layer or layers of a film that can increase the abuse resistance, toughness, or modulus of a film. In some embodiments the film comprises a bulk layer that functions to increase the abuse resistance, toughness, and/or modulus of the film. Bulk layers generally comprise polymers that are inexpensive relative to other polymers in the film that provide some specific purpose unrelated to abuse-resistance, modulus, etc. In an embodiment, the bulk layer comprises at least one member selected from the group consisting of: ethylene/alpha-olefin copolymer, ethylene homopolymer, propylene/alpha-olefin copolymer, propylene homopolymer, and combinations thereof.

The thickness of the bulk layer as a percentage of the total thickness of the film may be at least about, and/or at most about, any of the following: 1, 3, 5, 7, 10, 15, 20, 25, 30, 35, 40, 45, and 50 percent.

In embodiments, at least one film applied to the compressed fiber web is primarily made from polyolefins. In some embodiments the film includes materials selected from homogeneous ethylene/alpha-olefin copolymer, heterogeneous ethylene/alpha-olefin copolymer, ethylene homopolymer, ionomer, ethylene/vinyl acetate copolymer, polypropylene, biopolymers, and blends thereof. In embodiments, the film primarily ethylene homopolymer or copolymer. In other embodiments, the film is primarily a biodegradable aliphatic polyester such as polybutylene succinate.

To aid in recyclability, repulpability, compostability or sustainability, the total film content is kept low. In embodiments, the total weight of film(s), as compared to the total weight of total structure (fiber web plus films) is less 15%, or 10%. In embodiments, the low weight of the film results in the total film thickness being less than any of 60 microns, 55 microns, 50 microns, 45 microns or 40 microns.

In some embodiments a binder is deposited onto the fiber material prior to application of the film(s). In embodiments, the binder has moisture resistance properties. Exemplary binders include, but are not limited to sol-gel, natural wax (aqueous or 100% solid), polymer latex, hot melt adhesive coatings, starch-wax emulsions. In embodiments, the coatings are applied to the non-woven web or supporting layer. In embodiments, the coating deposition is applied at any of between 2 and 25 g/m², between 3 and 20 g/m² , between 4 and 15 g/m², less than 20 g/m² or less than 15 g/m².

Exemplary binders include but are not limited to repulpable hot melt coating available from Henkel, Munzing WU 2800, Munzing WU1512, Solenis PC350, Sun Sys 3007, Fluteshield Sonoco, Naiosol TPW, SX5PW702 Sun Chemical, SYSPW005 Sun Chemical, Epotal Sp 106D, Epotal S 440, Ulterion 535 OPV, Ecoshield, VAP2200R, PK265D, MC95, TopScreen SP200, TopScreen PC350, Cartseal HFU, Jonycryl HPB 1702, Caruba wax.

In embodiments, the tray is repulpable. As used herein, the term “repulpable” means a sample has a fiber yield from the repulpability test as described in the Aug. 16, 2013, revision of the “Voluntary Standard For Repulping and Recycling Corrugated Fiberboard Treated to Improve Its Performance in the Presence of Water and Water Vapor” provided by the Fibre Box Association of Elk Grove Village, Ill which is at least 80% based on the total weight, or 85% based on the bone dry fiber charge to the pulper.

Measuring for repulpability is done in accordance with the requirements of the Aug. 16, 2013, revision of the “Voluntary Standard For Repulping and Recycling Corrugated Fiberboard Treated to Improve Its Performance in the Presence of Water and Water Vapor” provided by the Fibre Box Association of Elk Grove Village, Ill. which is hereby incorporated in its entirety. In this regard, the disclosed food packaging tray can be recyclable in accordance with the requirements of the Aug. 16, 2013, revision of the “Voluntary Standard For Repulping and Recycling Corrugated Fiberboard Treated to Improve Its Performance in the Presence of Water and Water Vapor” provided by the Fibre Box Association of Elk Grove Village, Ill. The tray can be recycled as a single processing stream without requiring separation of materials.

All references to (and incorporations by reference of) ASTM protocols are to the most-recently published ASTM procedure as of the priority (i.e., original) filing date of this patent application in the United States Patent Office unless stated otherwise.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### PARTS LIST

100—Tray
102—Base
104—Sidewall
106—Upper periphery
200—Male portion
202—Surface
204—Protruding Section
250—Secondary protrusion
252—Advancement mechanism
254—Vent gap
300—Female portion
302—Surface
304—recessed opening
306—Deformable insert
364—Compressed fiber web
365—Roll
370—Heater
380—Thermoformer
381—Upper tooling
390—Thermoformed sheet
391—Thermoformed base
392—Thermoformed article
395—Punch out

1. A thermoforming apparatus comprising:
a. a female portion having an upper surface and a recessed opening;
b. a male portion have a protruding section and a secondary protrusion situated within the protruding section; and
c. at least one advancement mechanism in communication with the secondary protrusion, the advancement mechanism causing the secondary protrusion to extend beyond the surface of the protruding section.

2. thermoforming apparatus of claim 1 wherein the female portion further comprises a deformable insert in contact with at least a portion of the recessed opening.

3. The thermoforming apparatus of claim 1 wherein the at least one advancement mechanism is a spring.

4. The thermoforming apparatus of claim 3 wherein when no force is applied, the spring extends the secondary protrusion to extend beyond the surface of the protruding section.

5. The thermoforming apparatus of claim 1 wherein the at least one advancement mechanism is a piston.

6. The thermoforming apparatus of claim 1 wherein the secondary protrusion is a deformable material.

7. The thermoforming apparatus of claim 1 wherein the protruding section is a deformable material.

8. The thermoforming apparatus of claim 1 wherein the recessed opening includes a base section and at least one side wall that extends upward from and slightly outward from the base section.

9. A process for forming a fiber-based thermoformed tray comprising the steps of:
a. advancing a compressed fiber web of unwoven fiber material between a female portion and a male portion;
i. the female portion having an upper surface and a recessed opening;
ii. the male portion have a protruding section and a secondary protrusion situated within the protruding section;
iii. at least one advancement mechanism in communication with the secondary protrusion, the advancement mechanism causing the secondary protrusion to extend beyond the surface of the protruding section.
b. bringing the secondary protrusion into contact with the compressed fiber;
c. advancing the secondary protrusion causing the compressed fiber web to come in contact with a base section of the recessed opening of the female portion;
d. advancing the male portion causing the compressed fiber web to come in contact with the recessed opening;
e. applying sufficient force and heat to compress the fiber web between the female portion and the male portion to thermoform a tray; and
f. separating the male portion and the female portion.

10. The process of claim 9 wherein the step of advancing the secondary protrusion is caused by advancing the male portion.

11. The process of claim 9 wherein the secondary protrusion is movable independent of the male portion.

12. The process of claim 9 wherein the female portion further comprises a deformable insert.

13. The process of any of claim 12 wherein the deformable insert comprises a rubber material.

14. The process of claim 9 further comprising the step of applying a film to the compressed fiber web.
